(19) United States
(12) Patent Application Publication
(10) Pub. No.: US 2015/0028704 A1
(43) Pub. Date: Jan. 29, 2015

(54) Rotating Electrical Machine and Manufacturing Method Therefor

(71) Applicant: Hitachi Automotive Systems, Ltd., Hitachinaka-shi, Ibaraki (JP)

(72) Inventors: Kunihiro Ohsawa, Hitachinaka (JP); Yasuhiko Kimura, Hitachinaka (JP); Toshio Ishikawa, Hitachinaka (JP); Masahiko Honma, Hitachinaka (JP)

(73) Assignee: Hitachi Automotive Systems, Ltd., Ibaraki (JP)

(21) Appl. No.: 14/379,657

(22) PCT Filed: Jan. 23, 2013
(86) PCT No.: PCT/JP2013/051238

§ 371 Date: Aug. 19, 2014

(30) Foreign Application Priority Data
Mar. 14, 2012 (JP) 2012-056611

(51) Int. Cl. H02K 3/28; H02K 11/04; H02K 15/00; H02K 3/12

(52) U.S. Cl. CPC H02K 3/28; H02K 3/12; H02K 11/046; H02K 15/0056
USPC 310/71; 310/208; 310/68 D; 29/596

(57) ABSTRACT

A high-output, high-efficiency and high-quality rotating electrical machine is provided which has a stator shaped to avoid interference between coil end portions even in cases where the coil space factor of stator coils is raised and the stator coils are formed by winding continuous wires, each having a rectangular cross-section, for high productivity.

The stator coils include coils of plural turns straddling plural slots with the coils thus wound interconnected, to be continuous, with connectors. The stator has a stator core mounted, around an entire periphery thereof, with plural stator coils. The coil-end apex portions, disposed on both axial end sides of the stator core, are each approximately Z-shaped without any twisted portion. Each coil-end apex portion is divided into levels of different heights from the stator core end face in the axial direction. In this way, the thickness of overlapping coil layers is reduced to avoid interference between coil end portions. With the stator coils thus formed by winding wires each having a rectangular cross-section, the coil space factor in slots has been raised.

### TECHNICAL FIELD

The present invention relates to a rotating electrical machine such as a generator or a motor and a method of manufacturing the same.

### BACKGROUND ART

In recent years, energy saving has been promoted in the field of automobiles to meet environmental regulations and, with economical high-output, high-efficiency vehicle AC generators being in demand, techniques for realizing such AC generators by using, as an effective approach, an improved stator have been proposed.

In a stator coil format adopted as a way of increasing the output of a vehicle AC generator, a coil having a rectangular cross-section is used to raise the coil space factor in stator slots.

In the Patent Literature 1, a rotating electrical machine stator having layer-wound stator coils is proposed in which conductors each having a rectangular cross-section are used for a higher coil space factor and in which each coil end portion of each coil is crank-shaped involving no twisting. Also, in the Patent Literature 2, a rotating electrical machine is proposed which has a stator including approximately U-shaped segment coils each formed of wire having a rectangular cross-section. In configuring the stator, the segment coils are each inserted from the stator core axis direction, and then end portions of the segment coils are circumferentially twisted by a predetermined angle and are connected to predetermined coils by welding.

### CITATION LIST

### Patent Literature

Patent Literature 1: Japanese Unexamined Patent Application Publication No. 2008-104293
Patent Literature 2: Japanese Unexamined Patent Application Publication No. 2008-167567

### SUMMARY OF INVENTION

### Technical Problem

When the coil space factor of a coil is increased by the method disclosed in the Patent Literature 1, the thickness of coil layers overlapping in each coil end portion increases due to the relationship between the stator core diameter and slot length, resulting in an inadequate space for other coils to be mounted. This causes interference between coils, and slots become unable to completely accommodate required coils. Therefore, using the method disclosed in the Patent Literature 1 requires a coil end shape to be devised which can secure a gap between coils so as to avoid interference between coils.

According to the method disclosed in the Patent Literature 2, the segment coils require many parts on one end side thereof to be welded, causing quality-related concerns, for example, regarding productivity or quality such as insulating performance of welded portions. This applies, particularly, to high-voltage rotating electrical machines.

An object of the present invention is to realize a high-output, high efficiency electrical rotating machine using coils with a high coil space factor.

### Solution to Problem

The above object can be achieved by the invention defined by the appended claims. For example, the above object can be achieved by a rotating electrical machine which is provided with a stator and a rotor rotatably supported on an inner peripheral side of the stator via a gap formed between the rotor and the stator. The stator has an annular stator core which includes a plurality of slots open toward an inner peripheral surface of the stator and a stator coil. The stator coil includes a plurality of coil portions inserted in the slots with each coil portion being formed of a conductor having an approximately rectangular cross-section and connectors interconnecting the coil portions. In the rotating electrical machine, the coil portions are formed of the conductors wound to mutually differ in height in the rotation axis direction.

### Advantageous Effects of Invention

The present invention can realize a high-output, high-efficiency electrical rotating machine by using stator coils with a high coil space factor.

### BRIEF DESCRIPTION OF DRAWINGS

FIG. 1 is a sectional view of an overall structure of a rotating electrical machine according to a first embodiment of the present invention.

FIG. 2 is a perspective front view of a stator according to the first embodiment of the present invention.

FIG. 3 is a circuit diagram according to the first embodiment of the present invention.

FIG. 4 is a perspective view of a U1-phase coil A to be wound on the stator according to the first embodiment of the present invention.

FIG. 5 is a perspective view of a toroidal coil according to the first embodiment of the present invention.

FIG. 6 is a cross-sectional view of the toroidal coil shown in FIG. 5.

FIG. 7 is a diagram comparing a cross-sectional view of the toroidal coil shown in FIG. 5 and a cross-sectional view of an example of existing toroidal coil.

FIG. 8 is a view from the front side of the toroidal coil shown in FIG. 5.

FIG. 9 is a view from the rear side of the toroidal coil shown in FIG. 5.

FIG. 10 is a cross-sectional view of portions to be fitted in slots of the toroidal coil shown in FIG. 5.

FIG. 11 shows how to wind a toroidal coil according to the first embodiment of the present invention.

FIG. 12 shows a coil layout in a stator core according to the first embodiment of the present invention.

FIG. 13 is a view in the axial direction of the stator according to the first embodiment of the present invention.

FIG. 14 is a perspective view of a toroidal coil according to a third embodiment of the present invention.

FIG. 15 shows a coil layout in a stator core according to the third embodiment of the present invention.

### DESCRIPTION OF EMBODIMENTS

### First Embodiment

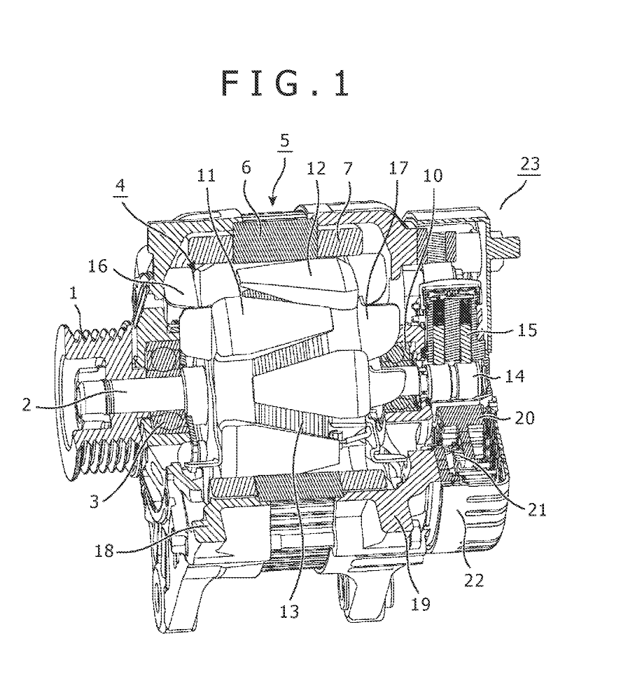

In the following, the structure of a rotating electrical machine according to a first embodiment of the present invention will be described with reference to FIGS. 1 to 9.

First, with reference to FIG. 1, the overall structure of a rotating electrical machine as an embodiment of the present invention will be described. In the present example, the rotating electrical machine being described is an AC generator for vehicle.

FIG. 1 is a sectional view of an overall structure of the rotating electrical machine according to the first embodiment of the present invention. A vehicle AC generator 23 has a rotor 4 and a stator 5. The rotor 4 has a field coil 13 mounted over a middle portion of a shaft 2. A rotor core including front claw poles 11 and rear claw poles 12, both formed of a magnetic material, is disposed as if covering the field coil 13 with the front claw poles 11 and the rear claw poles 12 sandwiching the field coil 13 from the front and rear sides, respectively. The front claw poles 11 and the rear claw poles 12 are oriented in the mutually opposing directions, respectively, and are disposed as if mutually engaging.

The rotor 4 is disposed inside the stator 5 to face the inner periphery of the stator 5 via a small gap. With the shaft 2 inserted through the inner races of a front bearing 3 and a rear bearing 10, the rotor 4 is rotatably supported. The stator 5 includes a stator core 6 and stator coils 7. The stator core 6 includes a stack of thin annular steel sheets with the stack having teeth projecting on the inner peripheral side thereof forming slots between the teeth. The stator coils 7 of different phases are mounted on the stator core by being inserted in the respective slots with each coil straddling plural teeth. The stator 5 is held, at both ends thereof, by a front bracket 18 and a rear bracket 19, respectively.

The shaft 2 is mounted with a pulley 1 at one end thereof. The shaft 2 is provided, at the other end thereof, with slip rings 14 which are in contact with brushes 15 and supply electric power to the field coil 13. The front claw poles 11 and rear claw poles 12 of the rotor 4 are provided, at their end face portions, with a front fan 16 and a rear fan 17, respectively, each fan having plural vanes on its outer peripheral side. The front fan 16 and the rear fan 17 are designed to let air flow through inside the stator 5. Namely, the centrifugal force generated when they turn introduces outside air into the interior of the stator 5 and discharges the air having cooled the interior of the stator 5 to outside.

In the present example, the stator coils 7 include coils of three phases. The lead wires of the respective stator coils are connected to a rectifier circuit 20. The rectifier circuit 20 includes rectifying devices such as diodes making up a full-wave rectifier circuit. When diodes are used, for example, their cathode terminals are connected to a diode connection terminal 21. Their anode terminals are electrically connected to the body of a vehicle AC generator. A rear cover 22 plays a role of a protective cover for the rectifier circuit 20.

Power generation operation will be described next. When the engine is started, the rotation of the engine is transmitted from the crankshaft to the pulley 1, then to the rotor 4 via the shaft 2. At this time, a DC current is supplied from the brushes 15 to the field coil 13 of the rotor 4 via the slip rings 14, thereby generating a magnetic flux which circles around the inner and outer peripheries of the field coil 13. As a result, the front claw poles 11 and rear claw poles 12 of the rotor 4 become circumferentially alternating north and south poles. The magnetic flux generated by the field coil 13 flows from the north poles of the front claw poles 11 through the stator core 6 to then circle around the stator coils 7 and arrives at the south poles of the rear claw poles 12 of the rotor 4, thereby forming a magnetic circuit circling around the rotor 4 and the stator 5. In this way, the magnetic flux generated in the rotor is interlinked with the stator coils 7, so that an AC induced voltage is generated in each of the stator coils 7 of U1-phase, U2-phase, V1-phase, V2W-phase, W1-phase, and W2-phase. Thus, AC induced voltages of a total of six phases are generated.

The AC voltages thus generated are full-wave rectified into a DC voltage by the rectifier circuit 20 including rectifier devices such as diodes. The DC voltage obtained through rectification is kept constant by controlling the current supplied to the field coil 13 using an IC regulator (not shown).

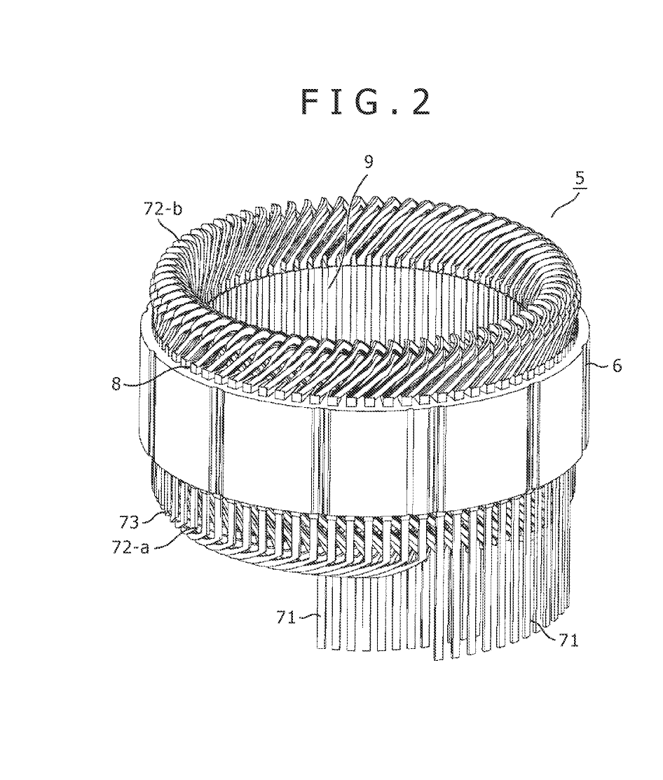

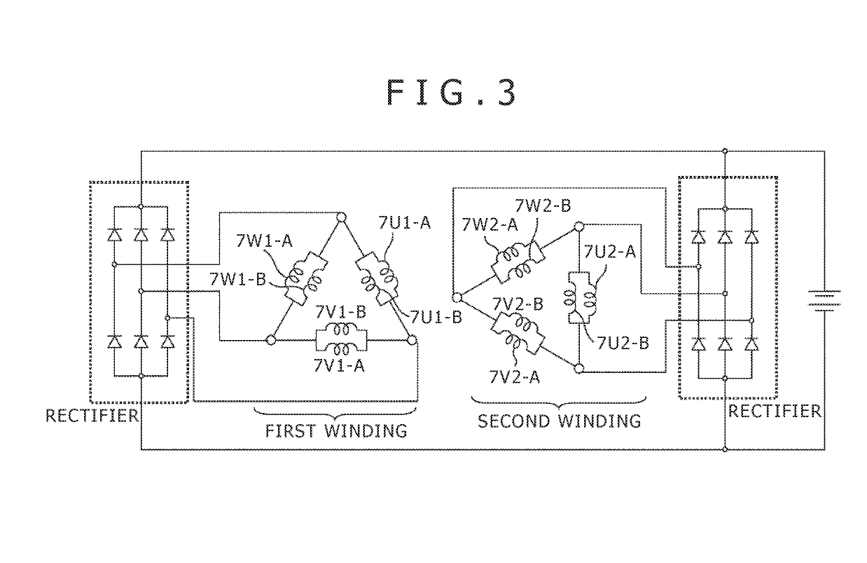

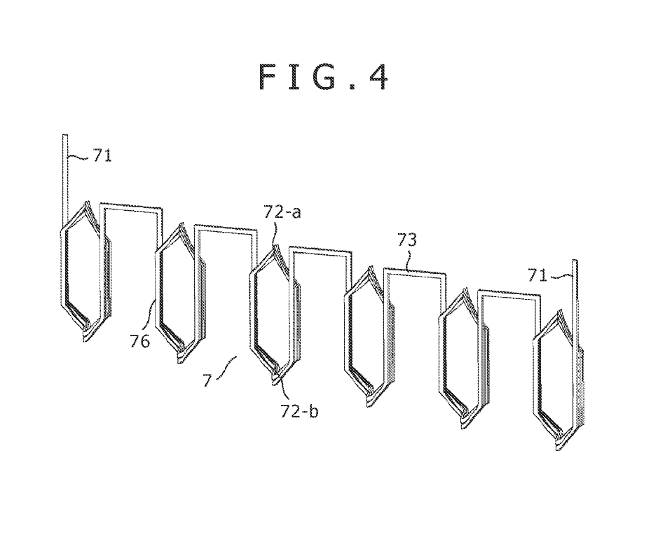

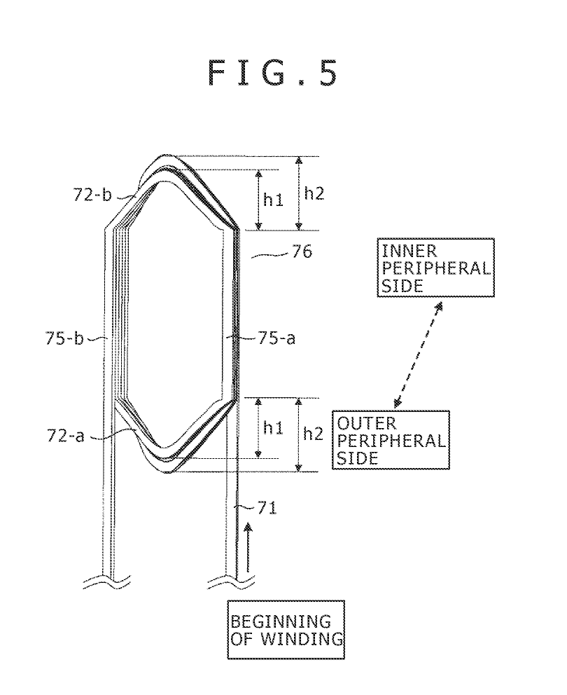

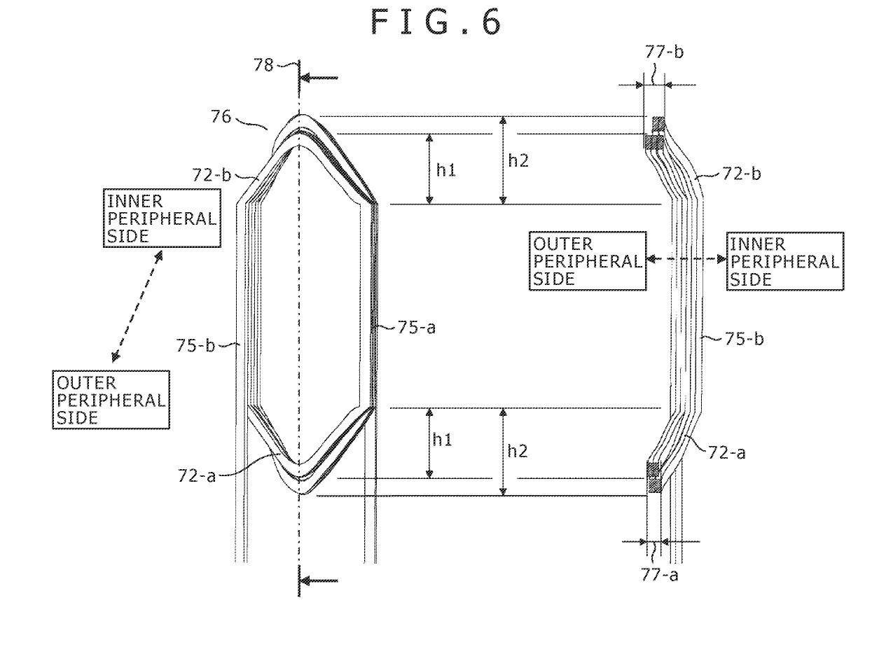

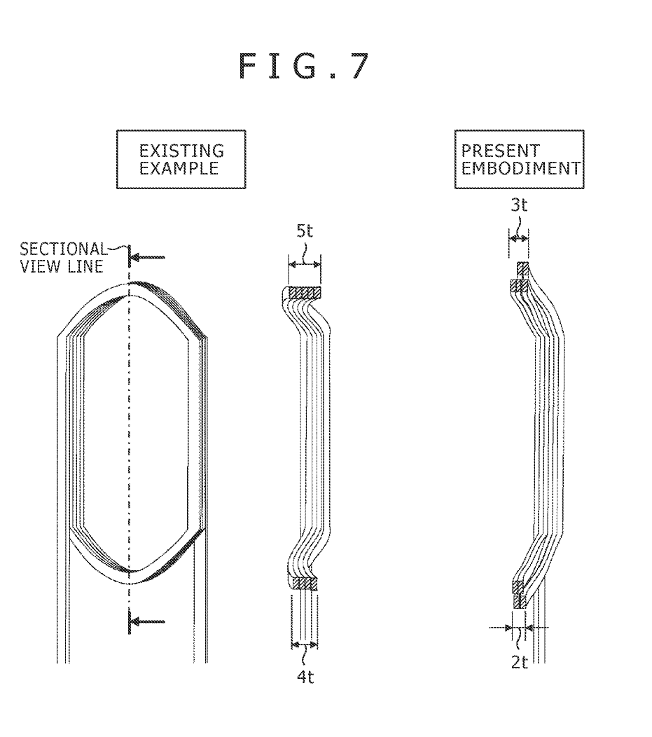

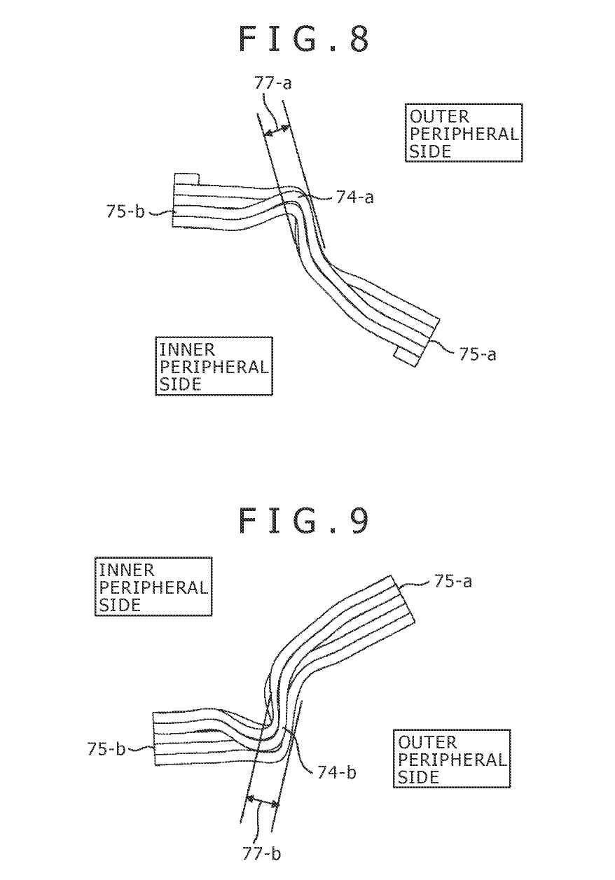

With reference to FIGS. 2 to 9, the structure of the first embodiment will be described. FIG. 2 is a perspective front view of the stator. FIG. 3 is a circuit diagram. FIG. 4 is a perspective view of a U1-phase coil A to be wound on the stator. FIG. 5 is a perspective view of a toroidal coil. FIG. 6 shows a view from the P side of the toroidal coil shown in FIG. 5. FIG. 7 shows a view from the F side of the toroidal coil shown in FIG. 5. FIG. 8 shows a coil arrangement in the stator core. FIG. 9 is a front view in the axial direction of the stator.

As shown in FIG. 2, the stator 5 includes an annular stator core 6 having plural slots which are formed on the inner peripheral surface of the stator core and are arranged in the peripheral direction and slot wedges 9 disposed on the innermost peripheral side of the slots. The slot wedges 9 hold the stator coils 7 of the respective phases that are fitted in the respective slots via U-shaped insulation paper fitted on the inner peripheral surface of each slot. In this example, the number of the slots is 72. The coil portions axially projecting from the slots on the stator core 6 are coil ends 72-a on the lead wire side and coil ends 72-b on the side opposite to the lead wire side with each pair of coil ends 72-a and 72-b projecting from different slots, respectively. As shown, 24 lead wires 71 are led out, are connected as shown in the wiring connection diagram of FIG. 3, and are connected to the rectifier 20.

Even though, in the present embodiment, as shown in FIG. 3, the stator coils include two types of coils A and B formed in delta connections which are connected in parallel, a rotating electrical machine can be configured also by forming coils A and B in star connections (Y connections) and connecting them in series.

As shown in FIG. 4, the stator coil 7 of U1 phase includes plural toroidally wound (toroidal) coils 76 interconnected with connectors 73. In the present example, the number of slots per pole per phase is 72 for 12 poles and 6 phases. The toroidal coils 76 total six. With the toroidal coils interconnected with connectors 73, a continuous coil composed of a total of 12 wires is formed. In the present example, each toroidal coil has five turns (5T).

As shown in FIG. 4, the U1-phase stator coil 7U1 is composed of a 7U1-A coil and a 7U1-B coil. The connectors 73 are arranged on the lead wire 71 side for both the 7U1-A coil and the 7U1-B coil. Namely, for the stator coil 7U1, all connectors are arranged on the lead wire side.

FIG. 5 shows the shape of a toroidal coil 76. The toroidal coil 76 is approximately hexagonally shaped and includes a lead wire 71, coil end portions 74 projecting from the stator core in the axial direction, coil slot portions 75 to be fitted in slot portions of the stator core, and a connector 73 for interconnection between toroidal coils. Each coil end portion 72 includes a coil turn portion which is Z-shaped with no twist at a coil end apex.

As shown in FIG. 5, the toroidal coil 76 leads from the lead wire 71 to a toroidal coil slot portion 75-a to be fitted in a slot portion of stator core, then to a coil end portion 72-b on the side opposite to the lead wire side. In the present example, the toroidal coil leading to the coil end apex, first forms a Z-shaped apex portion h2, to form a two-stage apex portion including apexes h1 and h2, then leads to a slot portion 75-b to be fitted in a slot portion.

Subsequently, the coil leads to form a coil end 72-a on the lead wire side as done in forming the coil end 72-b, then leads to the first slot portion 75-a to complete circling along a turtle back-like shape (approximately hexagonal), thereby forming one turn (1T) of the toroidal coil 76. Coil forming like this is repeated as many times as a predetermined number of turns required to achieve required characteristics of the rotating electrical machine. In the present example, the coil is divided, in each coil end portion thereof, into two levels, so that the conductor layers overlapping in each coil end portion are also divided into two levels. When the total number of conductor layers is odd on the lead wire side or on the side opposite to the lead wire side, the coil portion on the outer peripheral side is to include more conductor layers. The coil portion on the inner peripheral side is shaped to match the shape of the coil portion on the outer peripheral side, so that the magnitude of coil shaping becomes larger on the inner peripheral side. Hence, from the standpoint of productivity, the number of conductor layers is preferably smaller on the inner peripheral side requiring a larger magnitude of coil shaping.

FIG. 6 is a cross-sectional view of a toroidal coil 76. The conductor making up the toroidal coil 76 is a metal wire with an approximately rectangular cross-section. In the present example with each toroidal coil 76 having five turns (5T), the number of conductor layers is four in the coil end 72-a on the lead wire side with two conductor layers of the first and second turns in the upper level with an apex height of h2 and two conductor layers of the third and fourth turns in the lower level with an apex height of h1. In the coil end 72-b on the side opposite to the lead wire side, the number of conductor layers is five. Since, in the present example, the coil portion in the lower level with an apex height of h1 is on the outer peripheral side, the coil portion in the upper level with an apex height of h2 has two conductor layers of the first and second turns and the coil portion in the lower level with an apex height of h1 has three conductor layers of the third to fifth turns. In each coil end portion divided into two levels, the overlapping conductor layers are aligned in the axial direction within a thickness 77-a or 77-b of the conductor layers overlapping at height h1 on the outer peripheral side. For example, when the number of turns of a toroidal coil 76 is six, the number of conductor layers in the coil end portion on the lead wire side is five with two conductor layers at height h2 on the inner peripheral side and three conductor layers at height h1 on the outer peripheral side. On the side opposite to the lead wire side, the number of conductor layers in the coil end portion is six with three conductor layers each on the outer and inner peripheral sides. In this case, a gap is secured between the coil portions at heights h1 and h2 to allow the coil portions at heights h1 and h2 to be aligned in the axial direction. The gap is preferably about 1 mm so as to keep the coil end height low.

Even though, in the present embodiment, the toroidal-coil portions having different heights (h1 and h2) in the axial direction are provided on both sides of the stator poles, they may alternatively be provided only on one side of the stator poles.

In FIG. 7, the thicknesses of conductor layers overlapping in each coil end portion, divided into two levels, according to the present embodiment and the thickness of conductor layers in each coil end portion in an existing example case are compared. As shown, the thicknesses of conductor layers overlapping in coil end portions according to the present embodiment are ½ or ⅗ smaller than those in the existing example case.

FIG. 8 shows the coil end 72-a on the lead wire side of the toroidal coil 76 shown in FIG. 5 as seen from above in the axial direction. In a Z-shaped portion 74-a in the coil end portion, the coil portion in the upper level is aligned with the coil portion in the lower level within a width 77-a of the conductor layers overlapping in the coil portion in the lower level.

FIG. 9 shows the coil end 72-b on the side opposite to the lead wire side of the toroidal coil 76 shown in FIG. 5 as seen from above in the axial direction. In a Z-shaped portion 74-b in the coil end portion, the coil portion in the upper level is aligned with the coil portion in the lower level within a width 77-b of the conductor layers overlapping in the coil portion in the lower level.

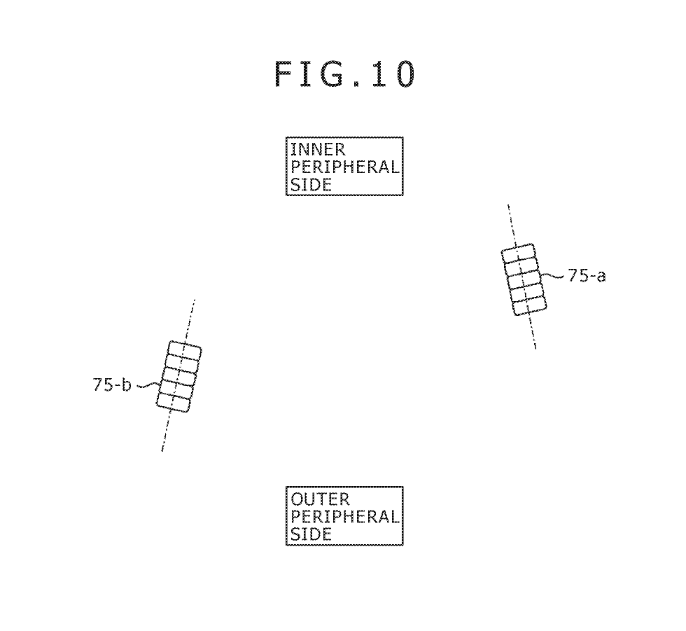

FIG. 10 is a cross-sectional view as seen in the axial direction of the 75-a and 75-b portions, each fitted in a slot, of the toroidal coil 76 shown in FIG. 5. In each slot, as many conductor layers, each having a rectangular cross-section, as the number of turns of the toroidal coil 76 are aligned with their wider sides entirely overlapping in the radial direction. In the present example, with the number of turns being five (5T), five conductor layers are overlapped on each of the outer peripheral side and the inner peripheral side.

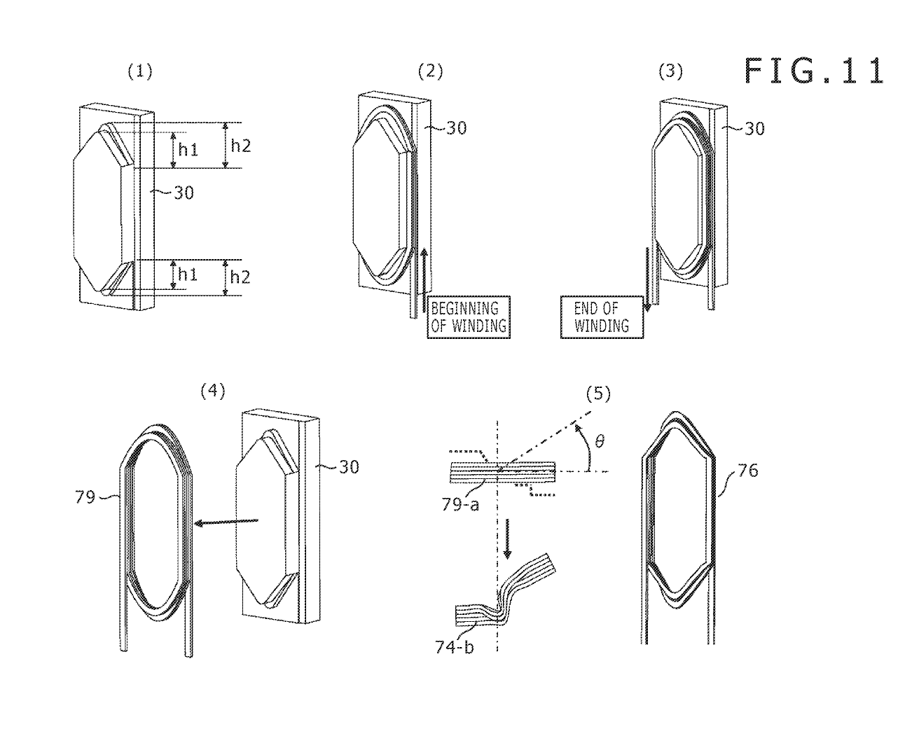

FIG. 11 shows steps of an example method of toroidal coil winding according to the present embodiment. FIG. 11-(1) shows a jig around which wire to form a coil is to be wound. Since each coil end portion is to be formed in two levels, the corresponding portions of the jig are each formed to have two apex heights h1 and h2. In forming a coil, the h2-height portions are first wound with a wire. FIG. 11-(2) shows the first two turns wound from the beginning of winding in the arrow direction along the apexes with height h2. FIG. 11-(3) shows the subsequent turns beginning with the third turn (3T) wound along the apexes with height h1. In the present example, the turns total 5 (5T). FIG. 11-(4) shows a toroidal coil 79 before being shaped of five turns (5T) removed from the jig in the arrow direction. FIG. 11-(5) shows how a toroidal coil is formed according to the present embodiment. The toroidal coil 76 before being finally shaped is formed into a final shape by entirely bending the coil end portion 79-a of the coil to angle θ while holding, at a portion indicated by a dotted line shown in FIG. 11-(5), the coil portions to be included in the h1 side and h2 side separately. At this time, the coil portions to be on the h1 side and on the h2 side are to be held separately, and the h2 side is to be pressed in to be above the h1 side. In this way, each coil end portion is aligned into a layered structure.

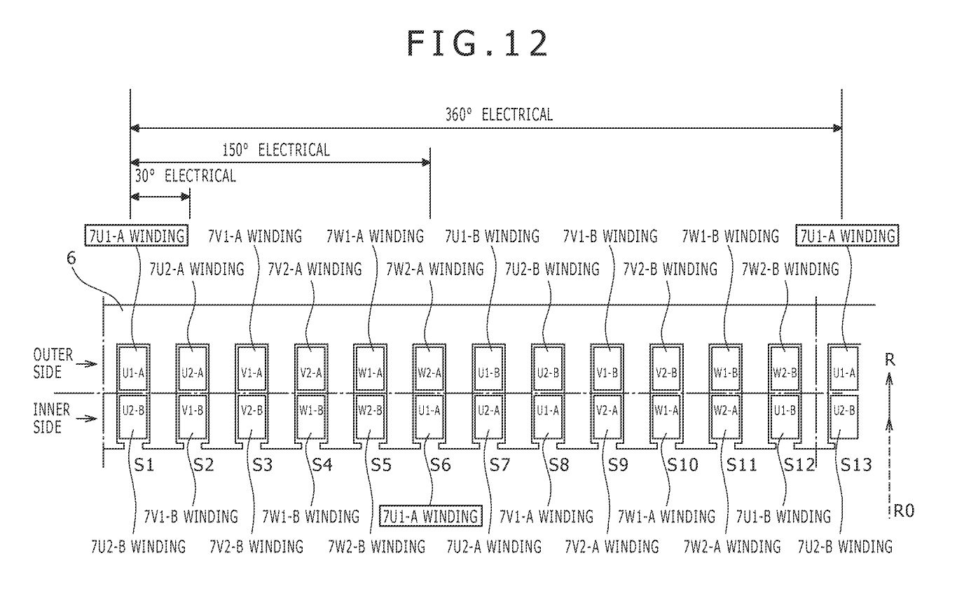

FIG. 12 shows a layout of the slots to hold the stator coils 7 mounted on the stator core.

The toroidal coils 76 are positioned 360° electrical apart with the positioning pitch equaling the pole pitch. The toroidal coils are wound at a short pitch, smaller than the pole pitch, to be 150° electrical apart, that is, to be less than 180° electrical apart.

When, as described above, the toroidal coils included in a stator coil are inserted in the respective slots, with each toroidal coil straddling plural teeth, with a winding pitch smaller than a full pitch which equals the pole pitch (i.e. a short pitch smaller than 180° electrical), the winding is called a short-pitch winding. When the toroidal coils included in a stator coil are inserted in the respective slots, each toroidal coil straddling plural teeth, with a winding pitch equaling a full pitch which equals the pole pitch (i.e. a full pitch equaling 180° electrical), the winding is called a full-pitch winding.

The stator coils of V1 to W2 phases are also arranged as described above.

The toroidal coils 76 shown in FIG. 5 are mounted on the stator core. On the stator core, the stator coils 7 are arranged to be in two side portions along the radial direction of the respective slots, i.e. to be on a slot opening side referred to as an inner side or on a side toward the outer periphery of the stator core 6 referred to as an outer side.

The stator coil 7 of each phase is divided into two types, coil A and coil B. Referring to FIG. 12, the two stator coils 7 of U1 phases, for example, are denoted as U1A which is a coil A and U1B which is a coil B. The toroidal coil U1A is disposed on the outer side of the first slot S1 and on the inner side of the sixth slot S6. The two portions are connected in a coil end portion to form a toroidal coil 76. Namely, each U1-phase toroidal coil is wound at a pitch of 150° electrical which is smaller than the pole pitch and smaller than 180° electrical. The toroidal coil U1B is disposed on the outer side of the seventh slot S7 and on the inner side of the eleventh slot S11. The two portions are connected in a coil end portion to form a toroidal coil 76. Namely, each U2-phase toroidal coil is wound at a pitch of 150° electrical which is smaller than the pole pitch and smaller than 180° electrical.

The toroidal coils of V1 to W2 phases are also arranged similarly to the above.

The toroidal coils arranged as shown in the slot layout diagram of FIG. 12 are interconnected with connectors 73 as shown in FIG. 4. The stator coils 7 of the respective phases are connected as shown in the connection diagram of FIG. 3 and are connected to a rectifier, thereby making up a vehicle AC generator having a stator provided with two three-phase connections according to the present first embodiment.

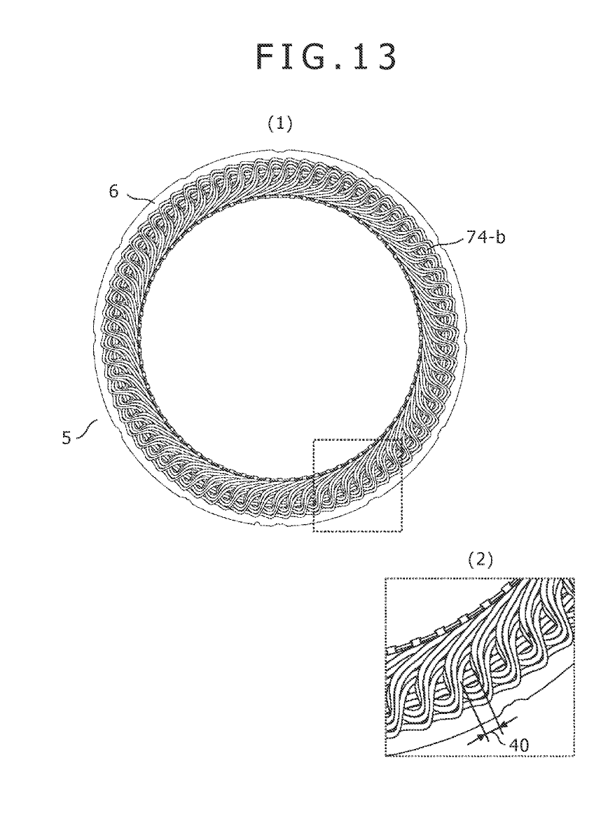

FIG. 13 shows a front view of the stator 5 including the toroidal coils 76 shown in FIG. 5.

FIG. 13(1) shows the coil end on the side opposite to the lead wire side as seen in the axial direction.

FIG. 13(2) is an enlargement of a portion of FIG. 13(1).

As shown in FIG. 13(2), the oblique portions of different levels each including a Z-shaped portion 74-b forming coil-end apexes are radially arranged with a gap 40 provided between adjacent Z-shaped portions 74-b. The Z-shaped coil portions including coil end apexes are divided into levels so as to reduce the thickness 77-b, shown in FIG. 6, of overlapping conductor layers and keep the spacing between coil turn portions uniform. This allows the stator to be configured causing no interference in the coil end portions.

Even when a higher-voltage motor is required, the stator can be fabricated with a uniform gap between the coil turn portions requiring no inter-phase insulation paper. This makes it possible to provide a high-quality stator at a low cost. Also, the coil portion in each coil end portion is divided into levels, that is, the heat radiating conductors are divided into levels resulting in larger heat radiation areas and enhanced cooling effects.

### Second Embodiment

According to the first embodiment described above, in each coil end portion arranged in two levels, the coil portion in the upper level is disposed on the inner peripheral side, but, alternatively, the coil portion in the upper level may be disposed on the outer peripheral side. Furthermore, when it is required to further reduce the thickness of overlapping conductor layers in each coil end portion to cope with an increase in the number of turns of the coil or an increase in coil space factor relative to slot length or in each slot, the number of levels in each coil end portion may be increased, so that the total thickness of overlapping conductor layers in each coil end portion can be divided by a larger number. In this way, interference between coil end portions can be avoided.

Also, in the structure of the first embodiment, the stator coils 7 of six different phases are mounted on the stator core 6, two each stator coils of different electrical angles are connected in parallel, then they are connected to a rectifier 20, but the same effect can be obtained also by connecting them in series. Connecting them in series reduces the number of required lead wires.

Even though delta connections are used in the first embodiment, the same effect can be obtained also by using star connections.

Also, for the first embodiment, the stator mounted with stator coils wound at a winding pitch of 5/6 (150° electrical) has been described, but the same effect can be obtained also by using a stator mounted with stator coils wound at a winding pitch of 4/6 (120° electrical) or a winding pitch of 6/6 (180° electrical).

Also, even though the stator mounted with two three-phase coils has been described, the same effect can be obtained also by using a stator mounted with multi-phase coils such as three-phase, five-phase or seven-phase coils.

### Third Embodiment

In connection with the second embodiment described above, it has been stated that the embodiment is feasible using a stator mounted with stator coils wound at a winding pitch of 5/6 (150° electrical) as in the first embodiment or, alternatively, mounted with stator coils wound at a winding pitch of 4/6 (120° electrical) or a winding pitch of 6/6 (180° electrical).

In the present embodiment, a single coil is wound at plural winding pitches. As an example, an arrangement in which about one half portion of each coil is wound at a winding pitch of 5/6 and the remaining portion is wound at a winding pitch of 6/6 will be described below.

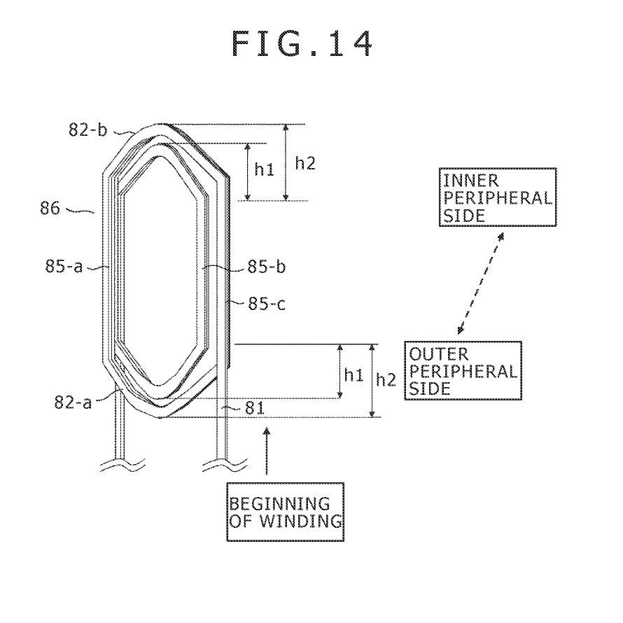

FIG. 14 shows the shape of a toroidal coil according to the present embodiment.

Of a toroidal coil 86, a coil portion 85-a is fitted in a slot on the outer side of the stator core, whereas the coil portion fitted in a slot on the inner side of the stator core is divided into a coil portion 85-b wound at a winding pitch of 5/6 (150° electrical) and a coil portion 85-c wound at a winding pitch of 6/6 (180° electrical).

In each of coil end portions 82-a and 82-b, the coil portion 85-b wound at a winding pitch of 5/6 makes up a lower level coil portion with an apex height of h1, and the coil portion 85-c wound at a winding pitch of 6/6 makes up an upper level coil portion with an apex height of h2.

According to the present embodiment, a coil is divided, in the coil height direction, into an upper level portion and a lower level portion and are wound at different winding pitches. The coil is also divided in its peripheral direction to be also divided through each of the coil end portions 82-a and 82-b. In this way, in each coil turn portion, the divided coil portions can be spaced apart wider and uniformly. Thus, the stator can be arranged causing no interference between coil portions in each coil end portion.

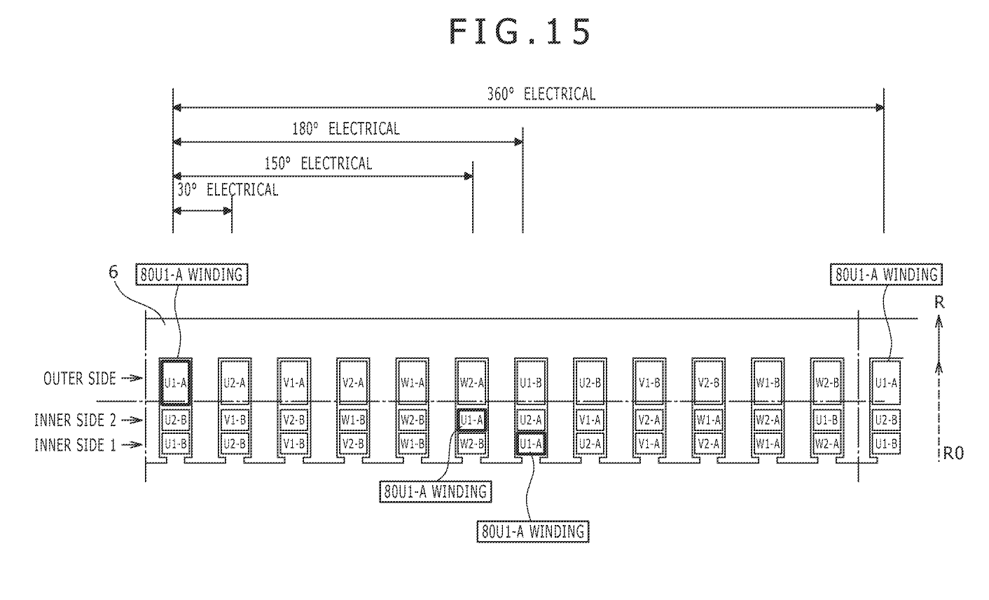

FIG. 15 shows a layout of the slots to hold the stator coils 80 mounted on the stator core.

The toroidal coils 86 are positioned 360° electrical apart with the positioning pitch equaling the pole pitch. The toroidal coils are divided into a portion wound on an inner side 2 at a pitch of 5/6 to be 150° electrical apart, i.e. at a short pitch smaller than the pole pitch to be less than 180° electrical apart and a portion wound on an inner side 1 at a pitch of 6/6 to be 180° electrical apart, i.e. at a full pitch equaling the pole pitch.

When, as described above, the toroidal coils included in the stator coils are inserted in the respective slots straddling plural teeth with a winding pitch smaller than a full pitch which equals the pole pitch (i.e., a short pitch smaller than 180° electrical), the winding is called a short-pitch winding. When the toroidal coils included in the stator coils are inserted in the respective slots straddling plural teeth with a winding pitch equaling a full pitch which equals the pole pitch (i.e. a full pitch equaling 180° electrical), the winding is called a full-pitch winding.

According to the coil arrangement of the present embodiment, intermediate characteristics coming between characteristics obtainable with a coil length based on a full pitch of 6/6 and characteristics obtainable with a coil length based on a short pitch of 5/6 can be obtained. Namely, advantages of both cases can be obtained including: higher inductive voltage realized by a full-pitch portion; reduced resistance resulting from a shorter coil length in a short-pitch portion; and higher output in a higher rotation speed range resulting from lower inductance realized by divided short-pitch winding.

The above embodiments have been described based on the assumption that the rotating electrical machine is a vehicle AC generator, but the present invention can also be applied to other types of rotating electrical machines, for example, a motor which outputs a rotating force or a motor generator capable of both generation and driving. Concerning motors, in particular, the invention can be applied to stators for use in, for example, motors for driving hybrid vehicles or electrically driven four-wheel vehicles or motors for driving pumps.

### LIST OF REFERENCE SIGNS

1 Pulley
2 Shaft
3 Front bearing
4 Rotor
5 Stator
6 Stator core
7 Stator coil
8 Insulation paper
9 Slot wedge
10 Rear bearing
11 Front claw pole
12 Rear claw pole
13 Field coil
14 Slip ring
15 Brush
16 Front fan
17 Rear fan
18 Front bracket
19 Rear bracket
21 Diode connection terminal
22 Rear cover
23 Vehicle AC generator
30 Winding jig
40 Coil end gap
71, 81 Lead wire
73, 83 Connector
76, 86 Toroidal coil
79 Toroidal coil before being shaped
80 Stator coil of third embodiment

1. A rotating electrical machine comprising:
a stator; and
a rotor rotatably supported on an inner peripheral side of the stator via a gap formed between the rotor and the stator,
the stator having an annular stator core which includes a plurality of slots open toward an inner peripheral surface of the stator and a stator coil which includes a plurality of coil portions inserted in the slots, the coil portions each being formed of a conductor with an approximately rectangular cross-section, and connectors interconnecting the coil portions,
wherein the coil portions are formed of the conductors wound to mutually differ in height in the rotation axis direction.

2. The rotating electrical machine according to claim 1,
wherein the coil portions are formed of the conductors wound by a plurality of turns to mutually differ in height in the rotation axis direction.

3. The rotating electrical machine according to claim 2,
wherein the coil portions are formed approximately in two levels in the rotation axis direction.

4. The rotating electrical machine according to claim 3,
wherein the coil portions are formed of the conductors wound, on one side or both sides of the stator core, to mutually differ in height in the rotation axis direction.

5. The rotating electrical machine according to claim 4,
wherein the coil portions are each inserted, at two locations, in different slots formed in the stator core, one of the two locations being on an outer peripheral side relative to the other of the two locations.

6. The rotating electrical machine according to claim 5,
wherein a highest portion of each of the coil portions is approximately Z-shaped, each of the coil portions being wound to be approximately hexagonal as a whole.

7. The rotating electrical machine according to claim 1, comprising:
a plurality of the stator coils,
wherein the stator coils being mounted on the stator core at mutually different electrical angles.

8. The rotating electrical machine according to claim 7, further comprising:
a rectification means that rectifies a voltage generated in the stator coils by rotation of the rotor.

9. The rotating electrical machine according to claim 7, further comprising:
a distribution means that distributes applied voltage to the stator coils.

10. The rotating electrical machine according to claim 3, wherein a conductor forming an approximately first level out of the approximately two levels is positioned on an inner peripheral side of the stator core relative to a conductor forming an approximately second level out of the approximately two levels.

11. A manufacturing method for a rotating electrical machine comprising a stator; and a rotor rotatably supported on an inner peripheral side of the stator via a gap formed between the rotor and the stator, wherein:
a plurality of coil portions are formed by bending conductors each having an approximately rectangular cross-section, the coil portions each including a portion differing in height from the other portion;
another portion of one of the coil portions is inserted on an outer peripheral side of a first slot formed in an annular stator core which makes up the rotor and which has a plurality of slots open toward an inner peripheral side of the stator; and
another portion of the one of the coil portions is inserted and fixed on an inner side of a second slot formed in the stator core.

12. The manufacturing method for a rotating electrical machine according to claim 10, wherein:
a second coil portion is formed by bending a second conductor having an approximately rectangular cross-section, the second coil portion including a portion differing in height from the other portion;
another portion of the second coil portion is inserted on an outer peripheral side of the second slot; and
subsequently, another portion of the coil portion is inserted and fixed on an inner peripheral side of the second slot.

13. The manufacturing method for a rotating electrical machine according to claim 12, wherein:
a plurality of coil portions are formed by bending a plurality of the conductors, the coil portions each including a portion differing in height from the other portion; and
after the conductors are fixed to the stator core, ends of the conductors are electrically interconnected.
